(19) United States
(12) Patent Application Publication
(10) Pub. No.: US 2017/0124897 A1
(43) Pub. Date: May 4, 2017

(54) SYSTEM AND METHOD FOR ENABLING A USER TO OVERCOME HIGH EMPATHY

(71) Applicants: Jonnalagadda Sasidhar, Sleepy Hollow, NY (US); Gopi Ambikapathi Ambekar, Bangalore (IN); Nagaranjini Honahalli Krishna, Hassan (IN)

(72) Inventors: Jonnalagadda Sasidhar, Sleepy Hollow, NY (US); Gopi Ambikapathi Ambekar, Bangalore (IN); Nagaranjini Honahalli Krishna, Hassan (IN)

(73) Assignee: DHARMA LIFE SCIENCES LLC, Sleepy Hollow, NY (US)

(21) Appl. No.: 15/077,946

(22) Filed: Mar. 23, 2016

Related U.S. Application Data
(63) Continuation-in-part of application No. 14/931,868, filed on Nov. 4, 2015.

(51) Int. Cl. G09B 9/00; G09B 19/00

(52) U.S. Cl. CPC G09B 9/00; G09B 19/00

(57) ABSTRACT

A system is provided for enabling a user to overcome high empathy. The system is configured to enable the user to engage in a first and a second activity in a virtual environment, directed to rewire a first and a second defective wiring, respectively. The first defective wiring results in an individual being biased to mirror the emotional state of others. The second defective wiring results in inability to weigh between the importance of self versus others. Symptom of the first and the second defective wirings is high empathy. Engagement in the second activity is enabled after the user has at least participated in the first activity. Automated instructions are provided to the user to engage in activities performed in a real world environment directed to rewire the first and the second defective wiring.

### CROSS REFERENCE TO RELATED APPLICATION

This application is a continuation-in-part application of U.S. patent application Ser. No. 14/931,868 filed Nov. 4, 2015 entitled SYSTEM AND METHOD FOR ENABLING A USER TO OVERCOME WEAK BEHAVIORAL TRAITS, which is hereby incorporated herein by reference. Benefits of priorities to all related applications are claimed.

### BACKGROUND

Unless otherwise indicated herein, the materials described in this section are not prior art to the claims in this application and are not admitted to be prior art by inclusion in this section.

The subject matter in general relates to behavioral traits in humans, and more particularly but not exclusively, the subject matter is directed to a technical solution to overcome high empathy, which is a weak behavioral trait.

An individual's behavior towards others, attitudes and characteristics, defines his personality. Each individual's personality is a combination of both positive and negative traits. A person may be driven by his positive traits at times and by negative traits at other times. As a result, to classify a person into a single personality type is difficult, as there are several different behavioral traits a person can have. Behavioral traits may be influenced by genes and/or by the environment where he grew up or may have spent most of his time during the stage of brain development. As an example, high empathy may be caused by genetic predisposition, growing up in an environment where parents lay lot of emphasis on emotions and helping and strong attachment relationships in life.

Understanding what makes people who they are has been a challenge in the world of psychology. One of the approaches used for determining the personality of a person is by way of taking a psychology based personality test. In such a test, the person answers a set of questions, and based on the answers gets a report detailing the type of personality that person may have. On the other hand, behavior of a person may be observed to determine weak personality traits in him. A person with high empathy may exhibit altruistic behavior i.e. necessity to act on a desire to help others and may have frequent mood swings to the extreme. Such a person may also be overwhelmed by crowded places, and often they slip out to be by themselves, are highly expressive and can become emotionally drained.

Negative or weak traits in a person can lead to difficulty in achieving their life goals. Conventionally, people try to overcome their weaknesses when one understands one's weaknesses or weak traits. An individual may approach a counselor or a psychologist with a view that, the counselor or the psychologist may be able to help him address his negative or weak trait. The person may have to undergo several sessions with the counselor. Such sessions may deal with the negative trait via a broad based general (not focused at the root of the weak trait) approach, which may be effective in the short run. For example, if a person is trying to deal with stress, the person may be advised to engage in regular exercise, outdoor games, engage socially and so on, which may prove effective to an extent for the time being.

Currently, there are multiple games and applications that may work in the same way as a counseling process. Even these games deal with the negative trait via a general approach. As an example if a person is not capable of reading at good speed, the person is subjected to games related to reading to improve his speed of reading. Such approach may be effective in the short run and does not address negative traits in a wholesome manner.

In light of the foregoing discussion there is a need for an improved technique to overcome high empathy, which can be classified as a weak personality trait based on the goals of the person.

### SUMMARY

An embodiment provides a system for enabling a user to overcome high empathy. The system includes an activity module. The activity module is configured to enable the user to engage in at least a first activity in a virtual environment. The first activity is directed to rewire a first defective wiring of the brain. The first defective wiring results in an individual being biased to mirror the emotional state of others. The activity module is further configured to enable the user to engage in at least a second activity in the virtual environment. The second activity is directed to rewire a second defective wiring of the brain. The second defective wiring results in an individual's inability to weigh between importance of self versus others. Symptom of the first and the second defective brain wirings is high empathy. Additionally, the activity module is configured to provide automated instructions to the user to engage in at least one activity, wherein the one activity is performed in a real world environment. The activity is directed to rewire the first defective wiring of the brain. Furthermore, the activity module is configured to provide automated instructions to the user to engage in yet another activity. The yet another activity is performed in the real world environment. The yet another activity is directed to rewire the second defective wiring of the brain.

Another embodiment provides a method for enabling a user to overcome high empathy. The method includes enabling the user to engage in at least a first activity in a virtual environment. The first activity is directed to rewire a first defective wiring of the brain. The first defective wiring results in an individual being biased to mirror the emotional state of others. The user is enabled to engage in at least a second activity in the virtual environment. The second activity is directed to rewire a second defective wiring of the brain. The second defective wiring results in an individual's inability to weigh between importance of self versus others. Symptom of the first and the second defective wirings is high empathy. Further, automated instructions are provided to the user to engage in at least one activity. The one activity is performed in a real world environment. The activity is directed to rewire the first defective wiring of the brain. Furthermore, automated instructions are provided to the user to engage in yet another activity. The yet another activity is performed in the real world environment. The yet another activity is directed to rewire the second defective wiring of the brain.

Yet another embodiment provides a system for enabling a user to overcome high empathy. The system includes an activity module configured to enable the user to engage in at least a first activity in a virtual environment, wherein the first activity is directed to rewire a first defective wiring of the brain, wherein the first defective wiring results in an individual being biased to mirror the emotional state of others. The activity module is further configured to enable the user to engage in at least a second activity in the virtual environment, wherein the second activity is directed to rewire a second defective wiring of the brain, wherein the second defective wiring results in inability to weigh between the importance of self versus others, wherein symptom of the first and the second defective wirings is high empathy, wherein engagement in the second activity is enabled after the user has at least participated in the first activity.

### BRIEF DESCRIPTION OF THE DRAWINGS

Embodiments are illustrated by way of example and not limitation in the Figures of the accompanying drawings, in which like references indicate similar elements and in which:

FIG. 1 is an exemplary architecture of an exemplary system 100 to overcome high empathy;

FIG. 2 is a block diagram of an exemplary activity module 200 to overcome high empathy;

FIG. 2A is a block diagram of an exemplary behavioral traits database 202 of the activity module 200;

FIG. 2B is a block diagram of an exemplary collection of games 204 present in the activity module 200 to overcome high empathy;

FIG. 2C is a block diagram of an exemplary actions database 206 of the activity module 200 to overcome high empathy; and

FIG. 3 illustrates a flowchart of an exemplary method for overcoming high empathy.

### DETAILED DESCRIPTION

I. OVERVIEW
II. PRINCIPLE
III. SYSTEM ARCHITECTURE
IV. MODULES OF SYSTEM TO OVERCOME HIGH EMPATHY
V. METHOD FOR OVERCOMING HIGH EMPATHY

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### I. Overview

Embodiments provide a technical solution to overcome high empathy, which is a weak behavioral trait. The solution is based on a principle that genetic and environmental factors (may be referred to as “cause”) cause defects in human brain wiring (may be referred to as “defect”), and such defects in human brain wiring express themselves in the form of high empathy (may be referred to as “symptoms”); hence, to overcome high empathy, the defective brain wirings have to be rewired, thereby providing a wholesome and long term solution to weak behavioral traits.

In an embodiment, a system is provided to overcome high empathy. The system may include an activity module. The activity module may be configured to enable the user to engage in activities in a virtual environment. The activities in the virtual environment facilitate rewiring of defective brain wirings, wherein the symptom of the defective brain wirings is high empathy. The activity module may be further configured to provide automated instructions to gradually expose the user to situations in a real environment. The situations may be generally uncomfortable to the user as a result of the defective brain wirings. Exposure to such situation facilitates rewiring of the defective brain wirings.

The activity in the virtual environment may be a brain game. There may be a plurality of levels in the brain game. Each level in the game may have to be successfully completed by the user to unlock a subsequent higher level in the game.

The real world activity may take place in the real world environment, subsequent to the brain games. There may be a plurality of levels in the real world activity.

### II. Principle

High empathy is the heightened ability to put oneself into the mental frame of another person to understand and feel his or her emotions.

High empathy is in fact a symptom or consequence of the way an individual's brain is wired. The way an individual's brain is wired is based on the joint influence of genetic and environmental factors. With regards to each kind of brain wiring, genetic and environmental factors may work together in different proportions.

With regards to high empathy, the brain of the person with high empathy is wired such that the person tends to mirror the emotional state of others. Additionally, the brain of the person with high empathy is wired such that the individual is unable to weigh between the importance of self versus others, which is another defective brain wiring. Such defective brain wirings may have been caused by one or more of genetic predisposition. Further, high empathy may be a result of strong attachment relationships in life and growing up in an environment where parents lay lot of emphasis on emotions and helping.

Embodiments provide a solution to rewire the defective brain wirings (addressing the defect) rather than just addressing the behavioral trait (symptom) without addressing the core defect. The solution is directed towards rewiring the defective brain wirings such that the ability to disengage individuals from others' emotions is increased and ability to weigh between the importance of self versus others, based on facts, is increased.

It is important to identify the brain wiring that results in development of a trait. A wholesome approach to overcome, eradicate or alleviate a negative or a weak behavioral trait in a person would be to implement ways to rectify defect in the brain wiring.

Brain wirings may be referred to as connections of neural pathways in the brain. These connections of the brain form beliefs, thought patterns and response patterns to external stimulation. Rewiring may be referred to as a process of creating new brain wiring and stimulating a person's existing brain wirings so that his beliefs, thought patterns and responses to external stimulation change for the better.

Individuals with high empathy are biased to mirror the emotional state of others and they are unable to weigh between the importance of self versus others. Different brain regions and neural network of the individual are responsible for such defects. Anterior Insula (AI), Orbito frontal Cortex (OFC), Anterior Cingulate Cortex (ACC), Premotor cortex (PMC) are important brain regions. When a person (high empathetic) evidences a situation, a network of neurons gets activated which includes neurons from ACC, AI, OFC, Amygdala, PMC etc. First, the emotion behind the situation is recognized by OFC. OFC carries forward this information to next level—ACC and AI. Both play an important role in implicit and explicit perception of another person's emotion. The perception is enhanced by the strong connection of amygdala neurons innervating AI and ACC. The representation of these activities is taken care by PMC neurons and behaviors such as altruism is observed.

### III. System Architecture

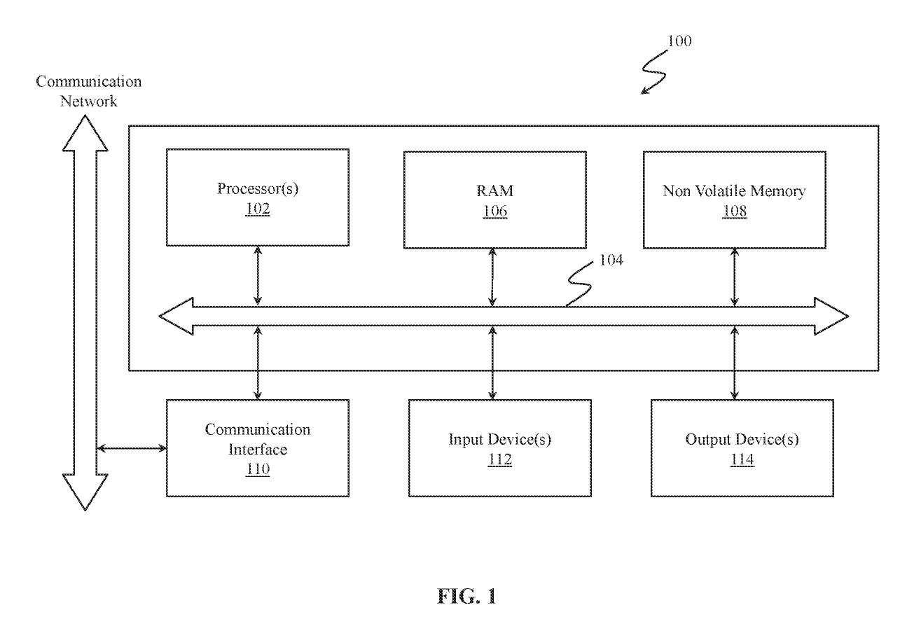

Referring to the figures, more particularly to FIG. 1, an exemplary architecture of an exemplary system 100 to overcome high empathy is provided. The system 100 include one or more processors 102, a bus system 104, a random access memory 106, a disk drive or non-volatile memory 108, a communication interface 110, input device(s) 112 and output device(s) 114. Further, functionality of the system 100 may be distributed across multiple devices that may be located remotely from each other.

The processor 102 may be any hardware which returns output by accepting signals, such as electrical signals as input. In one embodiment, processors 102 may include one or more processing units (CPUs). The processor(s) 102 may communicate with a number of peripheral devices via the bus system 104. The processor(s) 102 may be implemented as appropriate in hardware, computer-executable instructions, firmware, or combinations thereof. Computer-executable instruction or firmware implementations of the processor(s) 102 may include computer-executable or machine-executable instructions written in any suitable programming language to perform the various functions described.

Communications interface 110 may provide an interface to other communication networks and devices. The input devices 112 may include all possible types of devices and mechanisms for inputting information to system 100. The output devices 114 may include all possible types of devices and mechanisms for outputting information from the system 100. The system 100 may include memory that may store data and program instructions that are loadable and executable on the processor(s) 102, as well as data generated during the execution of these programs. The memory may be volatile, such as random access memory 106 and/or a disk drive or non-volatile memory 108.

### IV. Modules of System to Overcome High Empathy

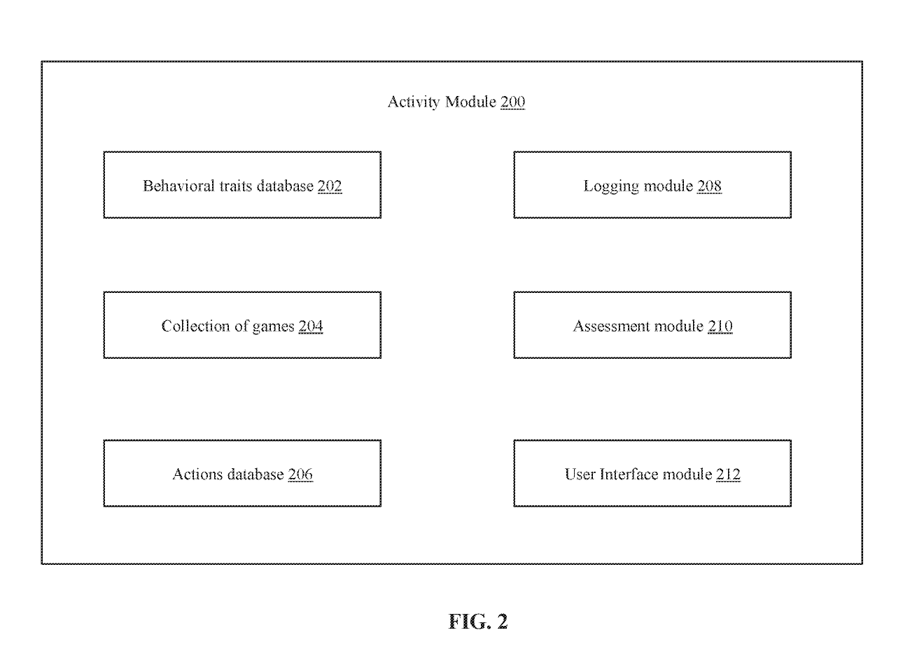

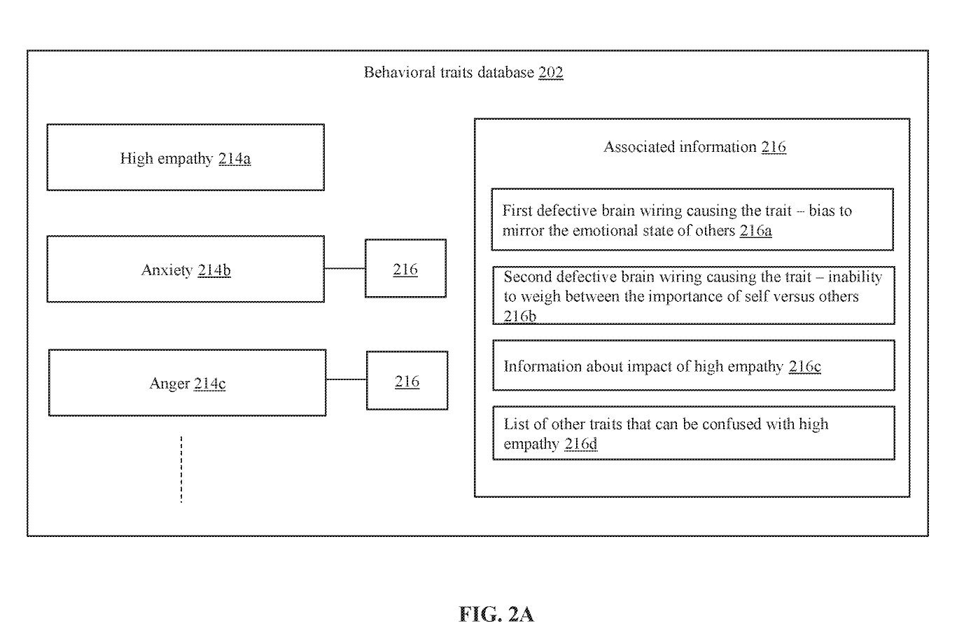

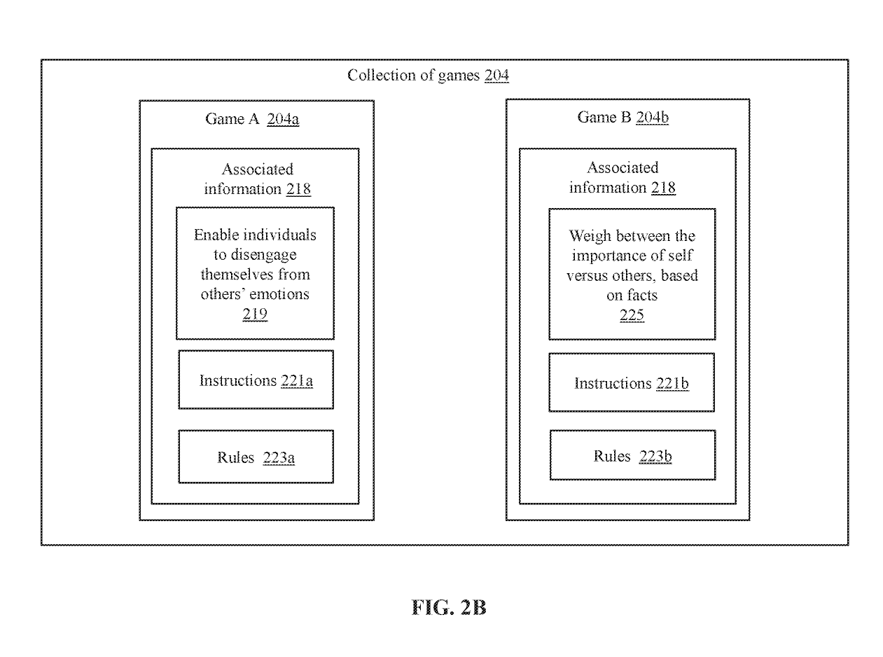

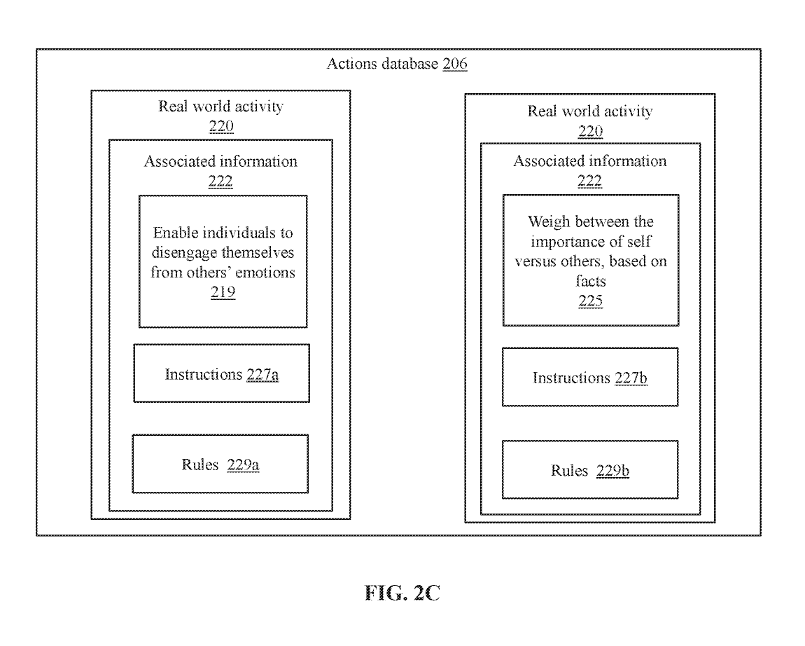

Referring to the figures, and more particularly to FIG. 2, the system 100 includes various modules for enabling users to overcome high empathy. The system 100 includes an activity module 200. The activity module 200 may be a gaming module or an application module. The activity module 200 may be hosted by a communication device that enables a user to play games. Examples of such communication devices may include smart phone, tablet, notebook, laptop and desktop computer, among other devices.

The activity module 200 may include a behavioral traits database 202, a collection of games 204, an actions database 206, a logging module 208, an assessment module 210 and a user interface module 212.

### Behavioral Traits Database 202

Referring to FIG. 2A, in an embodiment, the behavioral traits database 202 may include a list of behavioral traits 214. Examples of behavioral traits 214 include, but not limited to, high empathy 214a, anxiety 214b and anger 214c, among others. The traits database 202 may further include, with respect to one or more of the behavioral traits, information associated 216 with the trait 214.

With regards to high empathy 214a, the associated information 216 may include information corresponding to the defective brain wirings (defects) 216a, 216b causing high empathy (symptom of the defect), information about impact 216c of high empathy 214a on a person, and a list 216d comprising one or more traits that may be confused with high empathy 214a, among other information. Some or all of the associated information 216 may be displayed to the user of the activity module 200.

A first defective brain wiring 216a causing high empathy 214a is the brain wiring causing a bias to mirror the emotional state of others (like facial expressions, body language). A second defective brain wiring 216b causing high empathy 214a is the brain wiring causing inability to weigh between the importance of self versus others.

In an embodiment, the information corresponding to the first and second defective brain wirings 216a, 216b causing high empathy 214a enable the activity module 200 to select games, activities or actions to overcome high empathy 214a.

In an embodiment, displaying the information corresponding to the defective brain wiring (defect) 216a, 216b causing high empathy 214a helps the user in understanding the defects responsible for high empathy 214a, thereby motivating the user to follow the instructions provided by the activity module 200.

Information about impact 216c of high empathy can include one or more altruistic feeling, being overwhelmed by crowded places, often slipping out to be by themselves, being highly expressive, frequent mood swings to the extreme and emotionally drained, among others.

The list 216d of other traits that can be confused with high empathy 214a include sensitivity, submissiveness among others.

In an embodiment, the activity module 200 displays the information corresponding to the brain rewiring that the activity module 200 is attempting to achieve to overcome the weak behavioral trait 214, thereby enabling the user to understand the actual goal he will be instructed to work towards, which in turn can overcome high empathy 214a.

With regards to high empathy 214a, the brain rewiring attempted to achieve to overcome high empathy 214a includes rewiring the defective brain wirings 216a, 216b such that ability to disengage the individuals themselves from others' emotions is increased and ability to weigh between the importance of self versus others, based on facts, is increased.

In an embodiment, the activity module 200 may display the information corresponding to the causes (genetic or environmental) that resulted in the defective brain wirings (defect) 216a, 216b, which in turn resulted in high empathy 214a, thereby enabling the user to relate to the cause, defect and symptom of the defect, which results in a wholesome experience while working to overcome high empathy 214a.

### Collection of Games 204

The activity module 200 includes a collection of digital games 204, which are played in a virtual world. Each of the games 204 is used by the activity module 200 based on the brain rewiring, which the game 204 is capable of achieving.

Referring to FIG. 2B, in an embodiment, each game 204a-204b (may be referred to as game 204 or games 204) may include associated information 218. As an example, a game may be capable of achieving more than one type of brain rewiring. Alternatively, one single type of rewiring may be achieved through more than one game. Each game 204 includes data indicating the brain rewiring(s) 219, 225 it is capable of achieving, so that the activity module 200 can opt to present a choice of one or more games, which has the capability to achieve the brain rewiring, which the activity module 200 is attempting to achieve.

The associated information 218 may further include instructions 221 to be followed by the user to play the game 204. The associated information 218 may additionally include one or more rules 223. Examples of rules include rules for playing each game, rules to proceed to a higher level, scoring method in each level and time assigned to each level to reach the end of the level, among others.

In an embodiment, a higher level of the digital game 204 is unlocked based on predefined criteria.

In an embodiment, the higher level is unlocked upon repeatedly playing a previous level in the digital game 204 for a predefined number of times or duration of time.

In the example presented in FIG. 2B, three different games 204a-204b are included in the collection of games 204. The three games 204a and 204b can be used by the activity module 200 to correct the defective brain wirings 216a and 216b by rewiring the brain to increase the ability to disengage the individuals themselves from others' emotions 219 and increase ability to weigh between the importance of self versus others, based on facts 225.

Game A 204a is directed at rewiring 219 the brain to increase the ability to disengage the individuals themselves from others' emotions. The games, 204b is directed at rewiring 225 the brain to increase the ability to weigh between the importance of self versus others, based on facts.

Game A 204a may be designed to rewire the brain to increase the ability to disengage the individuals themselves from others' emotions. The instruction 221a may include recommendation to play the game 204a for a minimum of fifteen minutes every day, as an example. The rules 223a may allow proceeding to a next level in the game 204a once a desired level of performance is achieved.

Game A 204a may be a selection game, wherein a situation will be shown and one statement from two or more categories will be chosen randomly and displayed. The user has to select one statement from the two giving preference for the statement that helps to disengage from other emotions. One example is provided below.

### Situation:

A friend of yours is sad that he cannot go to his favorite movie.
Categories to choose from:
   Category 1: Disengaging from Others Emotions
Your friend can watch the movie later, as it's released just a day before.
Your friend has exams coming up and movie is not that important.
Your friend's sadness is temporary and he/she will be fine.
You are not responsible for him/her missing out on the movie.
Your friend gets sad for smallest of things.
Your friend has watched many movies in the past 15 days, so missing this movie now should not matter.
The movie has not received great reviews and hence skipping the movie is fine.
You have always been there for your friend earlier.
Your friend has other plans later in the evening and it will cheer him/her.
Your friend has skipped movies on his/her own before, so this shouldn't affect much.
   Category 1: Engaging with Others Emotion
He/she is your best friend and you can't see him/her being sad.
Your friend may feel lonely if you are not around.
He/She looks distressed and hence you should help out.
Your friend is silent and it is affecting you, hence you should help.
Your friend is not someone who would generally demand, so you should be more understanding to him/her now.
He/she feel bad to be left out of all the fun/conversation associated with the movie, so you should help him/her get to the movie.
Your friend is not that close to other friends, so you feel obliged to help.
Earlier, at times, the friend has been empathetic towards you, so it's your turn now.
Your friend seems to be bogged down with some issues; movie can be a good break.
Your friend is usually a jovial person and you wouldn't want to see him/her saddened.

Game B 204b may be designed to enhance one's ability to weigh between the importance of self versus others based on facts 225. The instruction 221b may include recommendation to play the game 204b for at least a predefined duration for a predefined number of days. The rules 223b may allow proceeding to a next level in the game 204b once a desired level of performance is achieved.

Game B 204b, may be a facts game, wherein a situation/event may be presented to the user. The user has to choose a correct answer based on a choice of facts provided that is related to the situation/event. One example is presented below where all the facts are given but only a subset of them is shown to the user based on which the user has to make a decision:
Situation/Event: Your colleague is trying hard to complete the assignment on time.
Categories to choose from

### Category 1: Giving Importance to Self

You have a deadline coming up.
You have recently been put in charge of a new project and been busy.
You would have been approached, if he/she needed help.
You have an important presentation and you need to prepare.
You have tight schedule and there is hardly any time to rest even.
You have other commitments for the day as well.
You are a buddy teammate to a new employee and need to give him/her your time.
If you try helping your colleague, you might miss out on meeting your friends at lunch.
You have to learn few aspects of the assignment before helping your colleague, which is time consuming.
You have just recovered from an illness and you will be drained, working extra hours.

### Category 2: Giving Importance to Others

Your colleague is also your good friend.
Its appraisals time and missing a deadline can affect your colleague's prospects.
The manager can create trouble for your colleague, if the assignment is submitted late.
Your colleague has a difficult task assigned and has been working alone.
Your colleague might feel low if you do not help.
Your colleague has joined recently and it might look bad to miss a deadline.
Your colleague may be pointed out in meetings henceforth, if he misses the deadline.
You have always been looked up to by your colleague.
Your colleague might feel isolated, if no one offers to help.
You are part of one team and you wouldn't want to let your colleague down.

### Actions Database 206

The actions database 206 includes information corresponding to a plurality of real world activities or sets of real world activities. Real world activities may include activities that are performed in a real world environment, as opposed to the digital games played in the virtual world (ex: games included in the collection of games 204).

Referring to FIG. 2C, the real world activities 220 or sets of real world activities 220 (may be referred by numeral 220) is used by the activity module 200 based on the brain rewiring 219, 225, which the real world activity 220 is capable of achieving.

Each real world activity 220 may include associated information 222. As an example, a real world activity may be capable of achieving more than one type of brain rewiring. Alternatively, one type of rewiring may be achieved through one or more real world activities. Each real world activity 220 includes data indicating the brain rewiring(s) 219, 225 it is capable of achieving, so that the activity module 200 can opt to present a choice of one or more real world activities 220, which has the capability to achieve the brain rewiring, which the activity module 200 is attempting to achieve.

The associated information 222 may further include instructions 227 to be followed by the user to perform the real world activity 220 or a set of real world activities 220. The associated information 222 may additionally include one or more rules 229. Examples of rules include rules to proceed to a higher level, scoring method in each level and time assigned to each level to reach the end of the level, among others.

The real world activity 220 may include plurality of levels. One or more of the levels of real world activity 220 may be directed at correcting the first defective brain wirings 216a by rewiring the brain to enable individuals to disengage themselves from others' emotions 219. Further, one or more of the levels of real world activity 220 may be directed at correcting the second defective brain wirings 216b by rewiring the brain to enable individuals to weigh between importance of self versus others, based on facts 225.

The real world activity 220 may be presented to the user after the user has participated in Game A 204a at least to a predefined extent. In another embodiment, real world activity 220 may be presented to the user after the user has participated in Game B 204b at least to a predefined extent. In yet another embodiment, exposure activity 220 may be presented to the user after the user has participated in both the games Game A 204a and Game B 204b at least to a predefined extent.

One or more levels of the real world activities 220 may be presented to the user after the user has at least participated in one or more games to a predefined extent that attempts to rewire 219 the first defective brain wiring 216a. Similarly, one or more levels of the real world activities 220 may be presented to the user after the user has at least participated in one or more games to a predefined extent that attempts to rewire 225 the first defective brain wiring 216b. As an example, levels 1 and 2 of real world activities are directed at rewiring the first defective brain wiring 216a, and levels 3, 4 and 5 of real world activities are directed at rewiring the second defective brain wiring 216b.

In a first level, the activity module 200 may provide instructions 227, which may include:
Imagine a situation, where your best friend gets a less score in the final exams and is sad. But you have got a pretty good score at the same time. Looking at your friend being sad, you might get affected. You can support your friend but at the same time you should disengage from your friend's emotions and give importance to yourself. It is important that you acknowledge your emotions at that point of time.
Imagine a situation, where you are at work and you hear your colleague in the next cabin talking about his trip to a foreign country. He/she is sharing the itinerary with other colleagues and is too excited about it. You can be happy for your colleague and wish him/her, instead of being overly excited as you are not going on a trip yourself
Imagine a situation, where you have a buddy, who was in a relationship for six years and has recently gone through a break up. You are being narrated as to why the break up happened and your buddy breaks down. It is fine to feel bad for your buddy and console him/her. But try to disengage from the emotions your friend is going through.
Imagine you are leaving late from home for work. You reach office at the end moment and you are running late for a meeting, which was scheduled 2 days before. In the meantime, your friend at work is irritated about not getting a cab to go out. You can ask the friend to check with another service provider or wait for some more time, as it's not peak time. Try to remain unaffected throughout.
Imagine you go in for a review meeting with your superior and your project gets good reviews and appreciation. You have put in a lot of effort and man hours into the project. And this is your first project. You are happy to receive such appreciative words. Once you come out of the meeting room, you find your colleague feeling low for not getting coffee at work. You can ask the colleague to go out or order online for coffee and to cheer up, by continuing to be happy than feeling low along with the colleague.

In a second level the activity module 200 may provide instructions 227, which may include:
In your daily life, when you are travelling by public transport, try not to internalize the conversations happening, in which you are not involved.
If your colleague at work is highly excited about the movie you are going for later in the day, try to remain calm. Being not highly excited in this situation, doesn't discount that you are happy as well.
In situations where you feel highly empathetic, like, when you are watching a melodrama and can feel the emotions being shown, pause for a moment and disengage from it by being aware that it is a movie and you yourself are not going through the situation.
When people come and cry out their sad stories to you, try not to personalize and get emotionally drained. Instead just lend a listening ear to them and leave it at that.
When you find your friend or family member sad, it's ok to ask the reason behind it. Try to remain unaffected and help only if they really need it.

In a third level, the activity module 200 may provide instructions 227, which may include:
Whenever you see yourself getting tuned to the mood or feelings of others, like for example, you are going for some important meeting and you hear a sad story from the cabbie about his place. Try not to be in the state of sadness and concentrate on your feelings/situations first.
Try to see things or situations from your perspective rather than from others' point of view, all the time. Like, when you have delegated work to your junior and it is not done on time. Try not to rationalize from his/her perspective.
When you find yourself in a situation, like, a stranger on the road looks lost and you would want to help him. Wait till you are approached. Whenever you tend to extend helping hand to others without even asked for, try to wait till you are approached.
When you are busy working on something and see someone being upset, do not jump to help leaving behind your priorities. Instead, address your priorities and then approach the person.

In a fourth level, the activity module 200 may provide instructions 227, which may include:
Try to stay composed when you are in certain situations or with people where you feel more fortunate than them and do not go on a guilt trip, as you are not responsible for it.
Try to take decisions rationally without getting influenced from others emotions in your daily life. Acknowledging the other person's emotions and getting influenced by those are two different things. Like, a friend of yours is on a spending spree to overcome a recent break up. He/she asks you to lend money. Do not get overwhelmed with emotions that your friend is going through. Instead make a decision based on other factors.
When there is a valid reason and you have to criticize someone at work/life, go ahead with it rather than putting yourself in that person's place and feeling bad. Because you are doing your duty and not demeaning the person.

In a fifth level, the activity module 200 may provide instructions 227 to mentor a person with high empathy as the individual, with whatever skills the individual has learnt in the course of this program. This person can be a family member, colleague or a friend in the individual's circle.

In an embodiment, the action database 206 further includes plurality of physical actions, mind actions and dietary actions, one or more of which may be presented to a user who is trying to overcome high empathy 214a.

Example of physical actions includes one or more physical activities, such as exercises and physical postures, among others. Example of mind actions may include meditation. Example of dietary actions may include adding specific food to one's diet or deleting specific food from the diet. As a further example, drinking black tea may be a dietary action and cutting down on rice consumption may be another dietary action.

### Logging Module 208

In an embodiment, the logging module 208 enables logging of the activities (ex: games, real world activities and other actions) performed by the user. The logging module 208 may record information corresponding to the activities performed by the user. The information may include one or more of, time of performance, date of performance, quantum of performance, success or failure consequent to an attempt to perform, and extent of success in performing the action, among others. The user may provide input that an activity has been performed. Such input may be used to log the activity in the logging module 208. Alternatively, the logging module 208 may be configured to automatically log the performance of an activity upon detection that the activity has been performed.

### Assessment Module 210

The assessment module 210 of the activity module 200 is configured to determine the performance of a user in each activity the user performs. The assessment module 210 may determine the user's score for each game and at each level in a game based on the log available in the logging module 208. Further, the assessment module 210 analyzes performance of the user in the real world activities and determines scores of each level of real world activity based on the log that is present in the logging module 208. The assessment module 210 may also determine status of the one or more behavioral trait 214 or the brain wiring causing the trait, after engaging in the activities, based on performance of activities suggested by the activity module 200.

### User Interface Module 212

The user interface module 212 may be configured to receive input from the user and display content to the user. The content displayed, can be, as an example, games, images, instructions, rules, information, haptic feedback and sound, among others.

### V. Method for Overcoming High Empathy

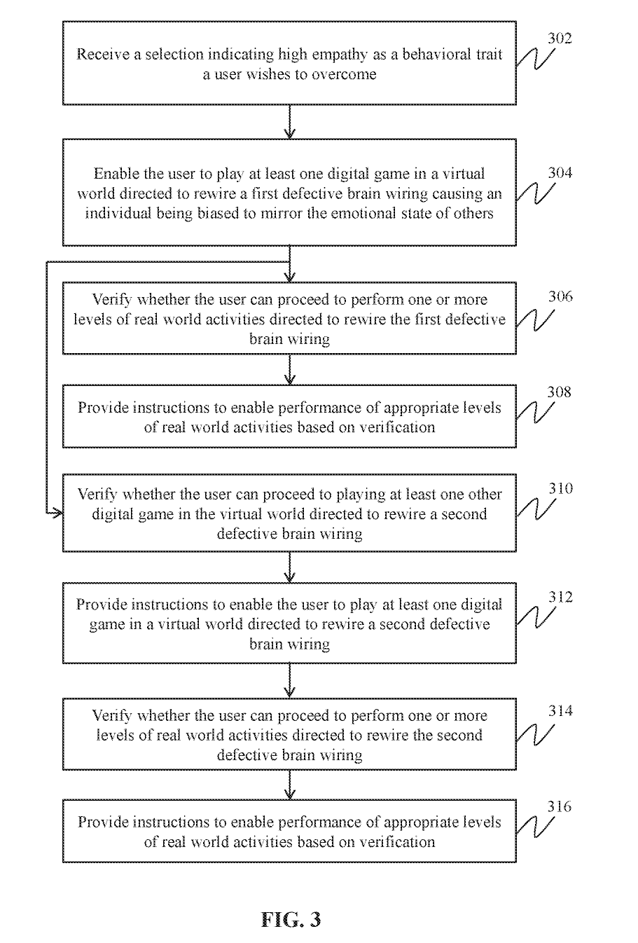

Now referring more particularly to FIG. 3, a method is provided for overcoming high empathy 214a. A selection indicating high empathy 214a as a behavioral trait which a user wishes to overcome is received at step 302. At step 304, a user is enabled to participate/play in at least one digital game 204a which is played in a virtual world. The digital game 204a is instrumental in rewiring 219 a first defective brain wiring 216a, whose symptom is exhibition of high empathy 214a. At step 306, verification is made to determine whether the user can proceed to perform one or more appropriate levels of real world activities 220 directed to rewire the first defective wiring 216a. In case it is determined that user can proceed, then at step 308, instructions are provided to enable the user to perform appropriate real world activity/activities 220. Preferably, the user is allowed to perform or instructed to begin performing appropriate real world activities 220 upon participating in the digital game 204a at least to a predefined extent, which is determined based on the desired rewiring. The real world activity 220a is instrumental in rewiring 219 the first defective brain wiring 216a, whose symptom is exhibition of high empathy 214a.

At step 310, verification is made to determine whether the user can proceed to playing at least one other digital game 204b in the virtual world directed to rewire a second defective brain wiring 216b. In case it is determined that user can proceed, then at step 312 the user is enabled to participate/play digital games 204b, which is played in a virtual world. The digital game 204b is instrumental in rewiring 225 the second defective brain wiring 216b, whose symptom is exhibition of high empathy 214a. Preferably, the user is allowed to proceed to playing at least one other digital game 204b upon participating in the game(s) instrumental in rewiring 219 the first defective wiring 216a at least to a predefined extent, which is determined based on the desired rewiring.

At step 314, verification is made to determine whether the user can proceed to perform one or more appropriate levels of real world activities 220. In case it is determined that user can proceed, then at step 316, instructions are provided to the user to enable the user to perform the appropriate levels of real world activity/activities 220. Preferably, the user is allowed to perform or instructed to begin performing appropriate real world activities 220 upon participating in the digital game(s) 204b at least to a predefined extent, which is determined based on the desired rewiring. The real world activity 220 is instrumental in rewiring 225 the second defective brain wiring 216b, whose symptom is exhibition of high empathy 214a.

Referring to the step (302) of receiving a selection indicating high empathy 214a, the user may be provided an option to select a behavioral trait that he would like to overcome. The activity module 200 may provide or recommend an option to select at least one weak behavioral trait to work on. The user may select at least one behavioral trait 214 that the user thinks he needs to work on, from a list of behavioral traits that may be displayed to the user via the user interface module 212. Alternatively, the user may input answers in response to a set of questions displayed to the user, which may determine what type of weak behavioral trait 214 the user may have. Upon selection of high empathy 214a, the activity module 200 may display a list 216d of other behavioral traits that can be confused with high empathy 214a, so that the user can select a more appropriate behavioral trait 214, which he desires to work on. The activity module 200 may further display the information corresponding to the brain wirings (defect) 216a, 216b causing the behavioral trait 214. The first defective brain wiring 216a causes bias to mirror the emotional state of others. The second defective brain wiring 216b causes inability to weigh between the importance of self versus others.

The activity module 200 may additionally display information about impact 216c of high empathy 214a to the user. In addition, the activity module 200 may display information corresponding to the brain rewiring 219, 225 that the activity module 200 is attempting to achieve to overcome high empathy 214a. Rewiring 219 of the first defective brain wiring 216a results in individuals' increased ability to disengage themselves from others' emotions. Rewiring 225 of the second defective brain wiring 216b results in increased ability to weigh between the importance of self versus others, based on facts.

Furthermore, the activity module 200 may display the information corresponding to the causes (genetic or environmental) that resulted in the defective brain wirings (defect) 216a, 216b.

Referring to the step (304) of enabling the user to play at least one digital game in the virtual world directed to rewire the first defective brain wiring 216a, the activity module 200 may select one or more digital games based on the capability of the digital games to achieve the desired brain rewiring 219.

The activity module 200 may provide a choice (one or more games) of games, from which the user may select. The activity module 200 may even indicate the effectiveness of each of the games in achieving the desired brain rewiring 219 or an aspect of rewiring.

In an embodiment, the activity module 200 is configured to recommend a plurality of games 204, wherein the recommendation indicates each of the games' 204 effectiveness to achieve the desired brain rewiring 219 or an aspect of rewiring.

The activity module 200 allows the user to play the selected game. The logging module 208 may log the performance of the user. The assessment module 210 may determine the performance scores using the log in the logging module 208. Further, based on the respective rules 223, the user is either allowed or denied access to other levels of the game 204.

Referring to step 306, the activity module 200 verifies whether the user can proceed to perform one or more levels of real world activities 220. Preferably, the activity module 200 recommends appropriate levels of real world activities 220 after the user has performed to a desired extent in the digital game(s) 204. Desired extent of performance can be, as an example, levels completed, score reached and duration over which the game 204 was played.

In an embodiment, the activity module 200 recommends (step 308) participating in one or more levels of real world activity 220 or a part thereof, after the user has performed to a desired extent in the digital game 204a. Likewise, the activity module 200 may recommend participating in one or more levels of real world activity 220 or a part thereof, after the user has performed to a desired extent in the digital game 204b. Desired extent of performance can be, as an example, levels completed, score reached and duration over which the game(s) were played.

In an embodiment, the activity module 200 recommends participating in a level or part of real world activity (ex: level of real world activity 220a) after the user has performed to a desired extent in a level of the digital game (ex: level of digital game 204a), wherein the level of the digital game prepares the user to participate in the level or part of the real world activity.

In an embodiment, the activity module 200 is configured to recommend a plurality of real world activities or sets of real world activities 220, wherein the recommendation indicates each of the real world activities' or sets of real world activities' 220 effectiveness to achieve the desired brain rewiring.

The logging module 208 may log the performance of the user. The assessment module 210 may determine the performance scores using the log in the logging module 208. Further, based on the rules 229, the user is either allowed or denied access to other levels of the real world activities or sets of real world activities.

Referring to step 310, the activity module 200 verifies whether the user can proceed to playing at least one or more other digital games in the virtual world directed to rewire the second defective brain wiring 216b.

In an embodiment, the activity module 200 recommends participating in digital games directed to rewire the second defective brain wiring 216b after the user has performed to a desired extent in the digital game(s) directed to rewire the first defective brain wiring 216a.

In another embodiment, the activity module 200 recommends participating in digital games directed to rewire the second defective brain wiring 216b after the user has performed to a desired extent in the digital game(s) and one or more levels of real world activity/activities 220 directed to rewire the first defective brain wiring 216a.

The activity module 200, based on the verification, enables (step 312) the user to play/participate in at least one other digital game 204b in the virtual world directed to rewire the second defective brain wiring.

Referring to step 314, the activity module 200 verifies whether the user can proceed to perform one or more appropriate levels of real world activity/activities 220 directed to rewire 225 the second defective brain wiring 216b. In an embodiment, the activity module 200 recommends (steps 314, 316) participating in real world activity 220 or part thereof after the user has performed to a desired extent in the digital game 204b.

In another embodiment, the activity module 200 recommends participating in digital game 204b after the user has performed to a desired extent in a level of the digital game 204a.

Additionally, the activity module 200 may provide instruction to perform mind actions, physical actions and dietary actions.

Each of the physical and dietary actions may have effect on one or more hormones corresponding to one or more traits, among others. While executing the physical action the energy expended in the body is more compared to the energy expended while playing brain game. Similarly, the mind action may involve thinking about the specific trait in a way which may change the structure of the brain by changing the Axons, Receptors and/or the number of Neurons. The dietary action may include consuming specific foods which changes one or more hormone levels.

The real world, mind, physical and dietary activities are carried out in a real environment. Automated instructions are provided as to when and how the activities may have to be carried out. Further, there may be instructions that one or more of the real world activities may have to be carried out simultaneously with the brain games and one or more of the activities may have to be carried out prior to or after engaging in brain game (digital games) and performing to a desired extent.

In an embodiment, upon selecting high empathy, the activity module 200 provides a scale operable by the user to select a position on the scale. The position may be indicative of the user's perception of how empathetic he is. Improvement in high empathy resulting from the rewiring of the brain achieved by the performance of the activities (virtual games or real world activities) enabled by the activity module 200 is reflected on the scale. Degradation of improvement in empathy resulting from the degradation of the rewiring of the brain due to premature halt in performance of the activities (virtual games or real world activities) enabled by the activity module 200 is also reflected on the scale.

The games and the real world activities change the neural connections in the brain. When these activities are carried out repeatedly, new neural connections are formed (brain plasticity) but if one stops carrying out these activities prematurely then slowly the neural connections die.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for enabling a user to overcome high empathy, the system comprising an activity module configured to:
enable the user to engage in at least a first activity in a virtual environment, wherein the first activity is directed to rewire a first defective wiring of the brain, wherein the first defective wiring results in an individual being biased to mirror the emotional state of others;
enable the user to engage in at least a second activity in the virtual environment, wherein the second activity is directed to rewire a second defective wiring of the brain, wherein the second defective wiring results in inability to weigh between the importance of self versus others, wherein symptom of the first and the second defective wirings is high empathy;
provide automated instructions to the user to engage in at least one activity, wherein the one activity is performed in a real world environment, wherein the activity is directed to rewire the first defective wiring of the brain; and
provide automated instructions to the user to engage in yet another activity, wherein the yet another activity is performed in the real world environment, wherein the yet another activity is directed to rewire the second defective wiring of the brain.

2. The system of claim 1, wherein the activities in the virtual environment are digital games.

3. The system of claim 1, wherein the activity module is further configured to provide the automated instructions to engage in the activity directed to rewire the first defective wiring to be performed in the real world environment, after the user has at least participated in the first activity.

4. The system of claim 1, wherein the activity module is further configured to provide the automated instructions to engage in the activity directed to rewire the second defective wiring to be performed in the real world environment, after the user has at least participated in the second activity.

5. The system of claim 1, wherein the activity module is further configured to enable the user to engage in the second activity, after the user has at least participated in the first activity.

6. A method for enabling a user to overcome high empathy, the method comprising:
enabling the user to engage in at least a first activity in a virtual environment, wherein the first activity is directed to rewire a first defective wiring of the brain, wherein the first defective wiring results in an individual being biased to mirror the emotional state of others;
enabling the user to engage in at least a second activity in the virtual environment, wherein the second activity is directed to rewire a second defective wiring of the brain, wherein the second defective wiring results in inability to weigh between the importance of self versus others, wherein symptom of the first and the second defective wirings is high empathy;
providing automated instructions to the user to engage in at least one activity, wherein the one activity is performed in a real world environment, wherein the activity is directed to rewire the first defective wiring of the brain; and
providing automated instructions to the user to engage in yet another activity, wherein the yet another activity is performed in the real world environment, wherein the yet another activity is directed to rewire the second defective wiring of the brain.

7. The method of claim 6, wherein the activities in the virtual environment are digital games.

8. The method of claim 6, wherein the automated instructions to engage in the activity directed to rewire the first defective wiring, to be performed in the real world environment, is provided after the user has at least participated in the first activity.

9. The method of claim 6, wherein the automated instructions to engage in the activity directed to rewire the second defective wirings, to be performed in the real world environment, is provided after the user has at least participated in the second activity.

10. The method of claim 6, wherein the user is enabled to engage in the second activity after the user has at least participated in the first activity.

11. A system for enabling a user to overcome high empathy, the system comprising an activity module configured to:
enable the user to engage in at least a first activity in a virtual environment, wherein the first activity is directed to rewire a first defective wiring of the brain, wherein the first defective wiring results in an individual being biased to mirror the emotional state of others; and
enable the user to engage in at least a second activity in the virtual environment, wherein the second activity is directed to rewire a second defective wiring of the brain, wherein the second defective wiring results in inability to weigh between the importance of self versus others, wherein symptom of the first and the second defective wirings is high empathy, wherein engagement in the second activity is enabled after the user has at least participated in the first activity.

12. The system of claim 11, wherein,
the first activity is directed to rewire the first defective wiring to enable the user to disengage from others' emotions; and the second activity is directed to rewire the second defective wiring to increase the ability to weigh between the importance of self versus others, based on facts.
